(19) United States
(12) Patent Application Publication
(10) Pub. No.: US 2014/0116945 A1
(43) Pub. Date: May 1, 2014

(54) NANOFIBER CONTAINING COMPOSITE STRUCTURES

(71) Applicants: Onur Y. Kas, Waltham, MA (US); Mikhail Kozlov, Lexington, MA (US); Gabriel Tkacik, Bedford, MA (US); David Nhiem, Lowell, MA (US); Philip Goddard, Merriimack, NH (US); Sherry Ashby Leon, Leominster, MA (US)

(72) Inventors: Onur Y. Kas, Waltham, MA (US); Mikhail Kozlov, Lexington, MA (US); Gabriel Tkacik, Bedford, MA (US); David Nhiem, Lowell, MA (US); Philip Goddard, Merriimack, NH (US); Sherry Ashby Leon, Leominster, MA (US)

(73) Assignee: EMD Millipore Corporation, Billerica, MA (US)

(21) Appl. No.: 14/118,490

(22) PCT Filed: Jul. 23, 2012
(86) PCT No.: PCT/US12/47865

§ 371 Date: Dec. 31, 2013

Related U.S. Application Data
(60) Provisional application No. 61/510,290, filed on Jul. 21, 2011.

(51) Int. Cl. B01D 69/02; B01D 67/00

(52) U.S. Cl. CPC B01D 69/02; B01D 67/0004
USPC 210/651; 264/6

(57) ABSTRACT

A nanofiber liquid filtration medium featuring an electrospun polymeric nanofiber layer produced on a smooth non-woven substrate.

### CROSS-REFERENCE TO RELATED APPLICATIONS

This application claims the benefit of priority of U.S. Provisional Patent Application No. 61/510,290, filed on Jul. 21, 2011, the entire content of which is incorporated by reference herein in its entirety.

### DESCRIPTION OF THE INVENTION

### Field of the Invention

The present invention relates generally to liquid filtration media. In certain embodiments, the invention provides a liquid filtration media and methods of using and making the same for the retention of microorganisms from a filtered liquid.

### Background of the Invention

Synthetic polymers have been formed into webs of very small diameter fibers, (i.e., diameters on the order of a few microns (μm) or less), using various processes such as melt blowing, electrostatic spinning and electroblowing. Such webs have been shown to be useful as liquid barrier materials and filters. Often they are combined with stronger substrates to form composites.

Biopharmaceutical manufacturing is constantly looking for ways to streamline operations, combine and eliminate steps, and reduce the time it takes to process each batch of pharmaceutical drug substances. At the same time, market and regulatory pressures are driving biopharmaceutical manufacturers to reduce their costs. Since bacteria, mycoplasma and virus removal account for a significant percentage of the total cost of pharmaceutical drug substance purification, approaches that increase a porous membrane's filtration throughput and reduce purification processing time are very much in demand.

With the introduction of new prefiltration media and the corresponding increases in throughput of bacteria, mycoplasma and virus retentive filters, the filtration of feed streams is becoming flux-limited. Thus, dramatic improvements in the permeability of bacteria, mycoplasma and virus retentive filters will have a direct beneficial impact on the cost of a bacteria, mycoplasma and virus filtration step(s).

Filters used in liquid filtration can generally be categorized as either fibrous non-woven media filters or porous film membrane filters.

Porous film membrane liquid filters or other types of filtration media can be used either unsupported or in conjunction with a porous substrate or support. Porous film liquid filtration membranes, which typically have pore sizes smaller than porous fibrous non-woven media, can be used in:

(a) microfiltration (MF), wherein particulates filtered from a liquid are typically in the range of about 0.1 micron (μm) to about 10 μm;

(b) ultrafiltration (UF), wherein particulates filtered from a liquid, are typically in the range of about 2 nanometers (nm) to about 0.1 μm; and

(c) reverse osmosis (RO), wherein particulate matter filtered from a liquid, are typically in the range of about 1 Å to about 1 nm.

Retrovirus-retentive membranes are usually considered to be on the open end of ultrafiltration membranes.

High permeability and high reliable retention are two parameters desired in a liquid filtration membrane. There is, however, a trade-off between these two parameters, and for the same type of liquid filtration membrane, greater retention can be achieved by sacrificing permeability. The inherent limitations of conventional processes for making liquid filtration membranes prevent membranes from exceeding a certain threshold in porosity, and thus limits the magnitude of permeability that can be achieved at any given pore size.

Fibrous non-woven liquid filtration media include, but are not limited to, non-woven media formed from spunbonded, melt blown or spunlaced continuous fibers; hydroentangled non-woven media formed from carded staple fiber and the like, and/or combinations thereof. Typically, fibrous non-woven media filters used in liquid filtration have pore sizes generally greater than about 1 μm.

Non-woven materials are widely used in the manufacture of filtration products. Pleated membrane cartridges usually include non-woven materials as a drainage layer (for example, see U.S. Pat. Nos. 6,074,869, 5,846,438, and 5,652,050, each assigned to Pall Corporation; and U.S. Pat. No. 6,598,749 assigned to Cuno Inc, now 3M Purification Inc.)

Non-woven microporous materials can also be used as a supporting screen for an adjacent porous membrane layer located thereon, such as Biomax® ultrafiltration membranes by EMD Millipore Corporation, of Billerica, Mass.

Non-woven microporous materials can also be used as supporting skeletons to increase the strength of a porous membrane located on the non-woven microporous structure, such as Milligard™ filters also available from EMD Millipore Corporation.

Non-woven microporous materials can also be used for “coarse prefiltration” to increase the capacity of a porous membrane placed downstream of the non-woven microporous material, by removing suspended particles having diameters that are generally greater than about 1 μm. The porous membrane usually provides a critical biosafety barrier or structure having a well-defined pore size or molecular weight cut-off. Critical filtration is characterized by expected and validatable assurance of a high degree of removal (typically >99.99%, as defined by specified tests) of microorganisms and viral particles. Critical filtration is routinely relied upon to ensure sterility of liquid drug and liquid biopharmaceutical formulations at multiple manufacturing stages, as well as at point of use.

Melt-blown and spunbonded fibrous media are often referred to as “traditional” or “conventional” non-wovens. Fibers in these traditional non-wovens are usually at least about 1,000 nm in diameter, therefore the effective pore sizes in traditional non-wovens are greater than about one micron. The methods of manufacturing traditional non-wovens typically lead to highly inhomogeneous fiber mats.

Historically, the random nature of conventional non-woven mat formation, such as by melt-blowing and spun-bonding, has led to the general assumption that non-woven mats are unsuitable for any critical filtration of liquid streams, and as such, filtration devices incorporating conventional non-wovens mats typically use these mats for prefiltration purposes only in order to increase the capacity of a porous critical filtration membrane placed downstream of the conventional non-wovens mats.

Another type of non-woven includes electronspun nanofiber non-woven mats, which, like “traditional” or “conventional” non-wovens have been generally assumed unsuitable for the critical filtration of liquid streams. (See for example, Bjorge et al., Performance assessment of electrospun nanofibers for filter applications, Desalination, 249, (2009), 942-948).

Electrospun polymeric nanofiber mats are highly porous, wherein the “pore” size is approximately linearly proportional to the fiber diameter, and the porosity is relatively independent of the fiber diameter. The porosity of an electrospun nanofiber mat usually falls in the range of about 85% to 90%, resulting in a nanofiber mat that demonstrates dramatically improved permeability when compared to immersion cast membranes having a similar thickness and pore size rating. The porosity advantages of electrospun polymeric nanofiber mats over porous membranes becomes amplified in the smaller pore size ranges typically required for virus filtration, because of the reduced porosity of UF membranes discussed supra.

Electrospun nanofiber non-woven mats are produced by spinning polymer solutions or melts using electric potential rather than meltblown, wetlaid or extrusion manufacturing processes used in making conventional or traditional non-wovens. The fiber diameters typically obtained by electrospinning are in the range of 10 nm to 1,000 nm, and are one to three orders of magnitude smaller than conventional or traditional non-wovens.

Electrospun nanofiber mats are formed by putting a dissolved or molten polymer material adjacent to a first electrode and applying an electrical potential such that the dissolved or molten polymer material is drawn away from the first electrode toward a second electrode as a fiber. In the process of manufacturing electrospun nanofiber mats, the fibers are not forced to lay down in mats by blown hot air or other mechanical means that can lead to a very broad pore size distribution. Rather, electrospun nanofibers form a highly uniform mat because of the mutual electrical repulsion between the electrospun nanofibers.

WO 2010/107503, assigned to EMD Millipore Corporation, teaches nanofiber mats having a specific thickness and fiber diameter offer an improved combination of liquid permeability and microorganism retention. The thinnest sample taught is 55 um thick with permeability of 4,960 lmh/psi, however neither the method to determine retention assurance nor the achieved level of assurance is described. Generally, nanofiber mats offer 2-10 times better permeability than their porous membrane counterparts of comparable retention, this is thought to be a consequence of the nanofiber mats having a higher porosity (˜90% vs. 70-80% for a typical wet casting porous membrane).

Electrospun nanofiber mats can be manufactured by depositing fibers on a conventional spun-bonded non-woven fabric (examples of a face to face interface of a non-woven and a nanofiber layer are taught in WO 2009/010020 assigned to Elmarco s.r.o.; and in US Pub. Patent Application No. 200910199717 assigned to Clarcor Inc., each incorporated herein by reference in their entirety). In each of these approaches, the roughness of the surface of the supporting non-woven fabric may propagate into the nanofiber layer causing potential non-uniformity of the nanofiber structure, thereby potentially compromising retention characteristics.

U.S. Pat. No. 7,585,437 issued to Jirsak et al. teaches a nozzle-free method for producing nanofibers from a polymer solution using electrostatic spinning and a device for carrying out the method.

WO 2003/080905 assigned to Nano Technics Co. LTD., incorporated herein by reference in its entirety, teaches an electroblowing process, wherein a stream of polymeric solution comprising a polymer and a solvent is fed from a storage tank to a series of spinning nozzles within a spinneret, to which a high voltage is applied and through which the polymeric solution is discharged. Compressed air, which may optionally be heated, is released from air nozzles disposed in the sides of, or at the periphery of, the spinning nozzle. The compressed air is directed generally downward as a blowing gas stream envelopes and forwards the newly issued polymeric solution, thereby aiding in the formation of a nanofibrous web, which is collected on a grounded porous collection belt located above a vacuum chamber.

U.S. Patent Publication No. 2004/0038014 to Schaefer et al. teaches a nonwoven filtration mat comprising one or more layers of a thick collection of fine polymeric microfibers and nanofibers formed by electrostatic spinning for filtering contaminants.

U.S. Patent Publication No. 2009/0199717 to Green teaches a method of forming electrospun fiber layers on a substrate layer, a significant amount of the electrospun fibers have fibers with a diameter of less than 100 nanometers (nm).

Bjorge et al., in Desalination 249 (2009) 942-948, teach electrospun Nylon nanofiber mats having a nanofiber diameter of about 50 nm to 100 nm, and a thickness of about 120 μm. The measured bacteria LRV for non-surface treated fibers is 1.6-2.2. Bjorge et al. purportedly conclude that bacteria removal efficiency of nanofiber electrospun mats is unsatisfactory.

Gopal et al., in Journal of Membrane Science 289 (2007) 210-219, teach electrospun polyethersulfone nanofiber mats, wherein the nanofibers have a diameter of about 470 nm. During liquid filtration, the nanofiber mats act as a screen to filter out particles above 1 micron (μm), and as a depth filter (e.g., prefilter) for particles under 1 micron.

Aussawasathien et al., in Journal of Membrane Science, 315 (2008) 11-19, teach electrospun nanofibers having a diameter of about 30 nm to 110 nm used in the removal of polystyrene particles having a diameter of about 0.5 μm to 10 μm

One reason why researches investigated collecting electrode properties is to control the orientation of the collected nanofibers on that electrode. Li et al., in Nano Letters, vol. 5, no. 5 (2005) 913-916, described introducing an insulating gap into the collecting electrode and the effects of the area and the geometrical shape of that introduced insulating gaps. They demonstrated that assembly and alignment of the nanofibers could be controlled by varying the collecting electrode pattern.

However, none of the nanofiber mat teachings discussed supra teach the relationship between nanofiber performance and substrate surface properties.

A number of methods have been published that focus on geometrical surface properties, such as roughness. For example, US Patent Application Publication No. 2011/0305872, titled “NON-FOULING, ANTI-MICROBIAL, ANTI-THROMBOGENIC GRAFT-FROM COMPOSITONS” describes changing surface roughness of a substrate by grafting a polymer layer, in order to change binding properties of biologicals on that substrate. An optical profilometry method was described to determine surface roughness of the substrate using Olympus LEXT OLS4000 laser confocal microscope.

U.S. Provisional Patent Application No. 61/470,705 assigned to EMD Millipore Corporation, teaches producing microorganism-retentive electrospun nanofiber mats supported by smooth microfiltration membrane substrates. By using a smooth membrane substrate, as opposed to a coarse non-woven substrate, to collect the mat of nanofibers, the same level of microorganism removal can be achieved but with a thinner nanofiber mat as compared to a nanofiber mat collected on a traditionally used coarse non-woven substrate. It is postulated that the surface roughness of the collection support directly influences the quality of the electrospun mat being deposited on it.

Replacing a coarse non-woven collection support with a smooth microfiltration membrane collection support may provide some performance advantages, but it may only achieve a very limited commercial benefit or success because microfiltration membrane supports cost considerably more compared to the much less expensive non-woven supports.

For critical filtration applications achieving high microorganism retention by itself is not enough but doing so in a reliable way with high assurance is required. In order to predict retention assurance statistical methods are often used, like censored data regression, to analyze lifetime data for reliability, where lifetimes are truncated. (Blanchard, (2007), Quantifying Sterilizing Membrane Retention Assurance, BioProcess International, v.5, No. 5, pp. 44-51)

What is needed is a porous electrospun nanofiber filtration medium that would be readily scalable, economical to manufacture, adaptable to processing volumes of sample fluids ranging from milliliters to thousands of liters, and capable of use with a variety of filtration processes and devices such that the electrospun nanofiber layer provides retention assurance and critical filtration properties, and the porous support the nanofiber layer is formed on provides a defect free, smooth and uniform surface. The invention is directed to these, as well as other objectives and embodiments.

### SUMMARY OF THE INVENTION

The present invention addresses, among other things, the non-uniformity often associated with coarse non-wovens used as substrates to make liquid filtration structures. The new liquid filtration media taught herein include porous nanofiber filtration structures having a polymeric nanofiber layer collected on a smooth non-woven support. When the nanofiber filtration media are used to filter a liquid or liquid streams, the smooth non-woven support can be situated both upstream or downstream of the polymeric nanofiber layer, or it could be detached from the nanofiber prior to use. Having the smooth non-woven side of the composite filtration structure as the support and the thin, uniform and small pore size nanofiber layer used as the retentive biosafety assurance layer, the liquid filtration platform taught herein exhibits permeability advantages over conventional porous membranes or nanofiber mats spun on coarse non-wovens. Another advantage of producing nanofiber mats on smooth non-woven substrates over producing them on coarse non-woven substrates is that, the smooth substrates provide a more reliable process where, using statistical analyses, predicted nanofiber layer thicknesses for necessary retention assurance could lead to even higher permeability advantages.

In another embodiment, the invention provides a nanofiber liquid filtration medium having a smooth non-woven support and a critical filtration porous nanofiber retentive layer collected on the smooth non-woven support. The thickness of the porous nanofiber layer ranges from about 1 μm to about 500 μm. The effective pore size of the porous nanofiber layer is generally defined by the fiber diameter, which is chosen based on the desired microorganism or particle to be retained. The effective pore size of the porous nanofiber layer, as measured by bubble point test provided infra, ranges from about 0.05 μm for retrovirus removal to about 0.5 μm for bacteria removal. Surface roughness of the substrate which the nanofiber mat is made on, is generally defined as the root mean square height of the surface of the substrate. Surface roughness is chosen based on the desired microorganism or particle to be retained. For example, to achieve high levels of reliable bacterial retention substrate RMS surface roughness of about 70 um is desired. Similarly for the retention of smaller particles or microorganisms i.e., mycoplasma and viruses, substrate RMS surface roughness of about 70 um would be expected to work as well.

In another embodiment, the invention provides a composite liquid filtration platform including an electrospun porous nanofiber layer having thickness ranging from about 10 μm to about 500 μm.

In further embodiments, the invention provides a composite liquid filtration platform including a porous electrospun nanofiber layer having thickness ranging from about 20 μm to about 300 μm.

In still other embodiments, the invention provides a composite liquid filtration platform including a porous electrospun nanofiber layer having thickness ranging from about 50 μm to 200 μm.

In another embodiment, the invention provides a composite liquid filtration medium structure having a smooth non-woven support having a substantially uniform thickness.

In another embodiment, the present invention is directed to a process of forming a porous composite liquid filtration platform from one or more porous electrospun polymeric nanofibers formed from a polymer solution using an electrospinning apparatus, and subjecting the solution to an electric potential greater than about 10 kV, and collecting the electrospun polymer fiber(s) on a porous supporting substrate having a smooth surface. The smooth surface structure of the supporting non-woven results in a smooth and a uniform porous nanofiber mat (unlike a nanofiber mat formed on a conventional non-woven collecting support have a coarse support surface). Smooth and uniform porous nanofiber mats typically have greater retention, i.e., porous nanofiber mats having the same thickness and permeability would have greater particle removal properties when produced on a smoother non-woven surface than on a coarse non-woven. Alternatively, porous nanofiber mats of similar retention would be thinner and more permeable if produced on a smooth non-woven support.

In another embodiment, the present invention is directed to a process of forming a porous composite liquid filtration platform from one or more porous electrospun polymeric nanofibers formed from a polymer solution using an electrospinning apparatus, and subjecting the solution to an electric potential greater than about 10 kV, and collecting the electrospun polymer fiber(s) on a porous supporting membrane having a smooth surface. Collecting nanofibers on a smooth non-woven rather than on a microfiltration membrane results in a higher productivity electrospinning process, i.e. the same thickness of nanofiber mat can be collected over a shorter period of time on a smooth non-woven than on a membrane. Greater productivity directly translates into a lower cost of final product.

In certain other embodiments, the invention provides a porous composite liquid filtration device including a porous composite liquid filtration platform having a liquid filtration composite medium featuring an electrospun polymeric porous nanofiber retentive biosafety assurance layer disposed on a smooth non-woven support.

Additional features and advantages of the invention will be set forth in the detailed description and claims, which follow. Many modifications and variations of this invention can be made without departing from its spirit and scope, as will be apparent to those skilled in the art. It is to be understood that the foregoing general description and the following detailed description, the claims, as well as the appended drawings are exemplary and explanatory only, and are intended to provide an explanation of various embodiments of the present teachings. The specific embodiments described herein are offered by way of example only and are not meant to be limiting in any way.

### BRIEF DESCRIPTION OF THE DRAWINGS

The accompanying drawings, which are incorporated in and constitute a part of this specification, illustrate the presently contemplated embodiments of the invention and, together with the description, serve to explain the principles of the invention

FIG. 1 is a graph of mat thickness vs. bacteria retention data for nanofibers spun on a coarse substrate (PBN-II) and the regression prediction

FIG. 2 is a graph of mat thickness vs. bacteria retention data for nanofibers spun on a smooth substrate (Cerex) and the regression prediction

FIG. 3 is a graph of mat thickness vs. bacteria retention data for nanofibers spun on a smooth substrate (Hirose) and the regression prediction

FIG. 4 is a graph of at thickness vs. bacteria retention data for nanofibers spun on coarse and smooth substrates and the regression predictions with reference lines at mat thicknesses corresponding to 99.9% retention assurance

FIGS. 5A, 5B and 5C are 3-D (three-dimensional) images taken by LEXT OLS4000 laser scanning confocal microscope of three substrates used to collect nanofibers on. Images were used for calculating surface roughness parameters and the calculated values are provided in FIG. 5D.

FIG. 6 is a graph of mat thickness vs permeability data grouped with respect to substrates and assay limit. Fully retentive data points over 10,000 lmh/psi are displayed. Reference lines at y-values correspond to the interpolated permeabilities expected from predicted nanofiber mat thicknesses for 99.9% retention assurance.

FIG. 7 is a graph of substrate RMS surface roughness vs. minimum thickness necessary for full retention with 99.9% assurance (the line is to guide the eye)

FIG. 8 is a graph of productivity difference of 120 nm nanofiber mats spun on microfiltration membrane and on smooth non-woven (thickness of nanofiber mats collected at various line speeds).

### DESCRIPTION OF THE EMBODIMENTS

All publications, including but not limited to patents and patent applications cited herein, whether supra or infra, are hereby incorporated by reference in their entirety to the same extent as if each individual publication, patent or patent application was specifically and individually indicated to be incorporated by reference.

Before describing the present invention in further detail, a number of terms will be defined. Use of these terms does not limit the scope of the invention but only serve to facilitate the description of the invention.

As used herein, the singular forms “a”, “an”, and “the” include plural referents unless the context clearly dictates otherwise.

For the purposes of this specification and appended claims, all numeric values expressing quantities of ingredients, percentages or proportions of materials, reaction conditions, and other numerical values used in the specification and claims, are to be understood as being modified in all instances by the term “about”, whether or not the term “about” is expressly indicated.

Accordingly, unless indicated to the contrary, the numerical parameters set forth in the following specification and attached claims are approximations. Notwithstanding that the numerical ranges and parameters setting forth the broad scope of the invention are approximations, the numerical values set forth in the specific examples are reported as precisely as possible. Moreover, all ranges disclosed herein are to be understood to encompass all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10. e.g., 5.5 to 10.

The term “calendering” refers to a process of passing a web through a nip between two rolls. The rolls may be in contact with each other, or there may be a fixed or variable gap between the roll surfaces.

The terms “filter medium”, “filter media”, “filtration media”, or “filtration medium” refer to a material, or collection of material, through which a fluid carrying a microorganism contaminant passes, wherein microorganism is deposited in or on the material or collection of material.

The terms “flux” and “flow rate” are used interchangeably to refer to the rate at which a volume of fluid passes through a filtration medium of a given area.

The term “nanofiber” refers to fibers having diameters or cross-sections generally less than about 1 μm, typically varying from about 20 nm to about 800 nm.

The terms “optional” or “optionally” mean that the subsequently described event or circumstance may or may not occur, and that the description includes instances where the event occurs and instances where it does not.

When a non-woven fabric having specific and narrowly defined surface properties is selected and used as a collection substrate for a nanofiber mat, the final properties and the reliability of achieving those properties can be dramatically improved compared to using a conventionally used traditional non-woven substrate. This obviates the need for using a potentially more expensive membrane as a smooth nanofiber collection substrate.

The composite liquid filtration platforms of the present invention include, for example, a composite liquid filtration medium featuring a porous electrospun nanofiber liquid filtration layer deposited on a smooth non-woven substrate. The electrospun nanofibers preferably have an average fiber diameter of about 10 nm to about 150 nm, a mean pore size ranging from about 0.05 μm to about 1 μm, a porosity ranging from about 80% to about 95%, a thickness ranging from about 1 μm to about 100 μm, preferably from about 1 μm and about 50 μm, more preferably between 1 μm and 20 μm. The composite liquid filtration platforms taught herein have a water permeability greater than about 100 LMH/psi.

In addition, the composite liquid filtration platforms taught herein have a high retention of microorganisms providing at least 6 LRV of bacteria, and preferably at least 8 LRV of bacteria.

The electrospun nanofibers are prepared from a broad range of polymers and polymer compounds, including thermoplastic and thermosetting polymers. Suitable polymers include, but are not limited to, nylon, polyimide, aliphatic polyamide, aromatic polyamide, polysulfone, cellulose, cellulose acetate, polyether sulfone, polyurethane, poly(urea urethane), polybenzimidazole (PBI), polyetherimide, polyacrylonitrile (PAN), poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene), polymethylmethacrylate (PMMA), copolymers, derivative compounds and blends and/or combinations thereof.

In one embodiment taught herein, the electrospun fibrous mat is formed by depositing electrospun nanofiber(s) from a nylon solution. The resulting nanofiber mat preferably has a basis weight between about 1 g/m² and about 20 g/m², as measured on a dry basis, (i.e., after the residual solvent has evaporated or been removed).

In other embodiments taught herein, the composite liquid filtration platform includes a variety of porous smooth non-woven substrates or supports that can be arranged on a moving collection belt to collect and combine with electrospun nanofiber(s) forming an electrospun nanofiber mat thereon.

Non-limiting examples of single or multilayered porous substrates or supports include smooth non-wovens. In other non-limiting examples the smooth non-woven support has a substantially uniform thickness. Smooth non-wovens are produced from a variety of thermoplastic polymers, including polyolefins, polyesters, polyamides, etc.

The homogeneity of the non-woven substrate of the composite filtration medium that captures or collects the electrospun nanofibers was observed to at least partially determine the properties in the resulting nanofiber layer of the final composite filtration structure. For example, we have observed a smoother surface of the substrate used to collect the electrospun nanofibers, the more uniform the resulting nanofiber layer structure.

Smoothness of the supporting nonwoven pertains to geometrical smoothness, or lack of rough surface features that have dimensions greater than one fiber diameter of the non-woven, as well as low hairiness, i.e. a small number of fibers and/or loops that protrude beyond the surface.

Geometrical smoothness can be easily measured by a number of common techniques, for example mechanical and optical profilometry, visible light reflectivity (gloss metering) and other techniques known to those skilled in the art.

In certain embodiments of the composite liquid filtration platform taught herein, an electrospun nanofiber layer is bonded to a smooth non-woven support. Bonding may be accomplished by methods well known in the art, including but not limited to thermal calendering between heated smooth nip rolls, ultrasonic bonding, and through gas bonding. Bonding the electrospun nanofiber layer to the non-woven support increases the strength of the composite, and the compression resistance of the composite, such that the resulting composite filtration medium is capable of withstanding forces associated with forming the composite filtration platform into useful filter shapes and sizes, or when installing the composite filtration platform into a filtration device.

In other embodiments of the composite liquid filtration platform taught herein, the physical properties of the porous electrospun nanofiber layer such as thickness, density, and the size and shape of the pores may be affected depending on the bonding methods used between the nanofiber layer and the smooth nonwoven support. For instance, thermal calendaring can be used to reduce the thickness and increase the density and reduce the porosity of the electrospun nanofiber layer, and reduce the size of the pores. This in turn decreases the flow rate through the composite filtration medium at a given applied differential pressure.

In general, ultrasonic bonding will bond to a smaller area of the electrospun nanofiber layer than thermal calendaring, and therefore has a lesser effect on thickness, density and pore size electrospun nanofiber layer.

Hot gas or hot air bonding generally has minimal effect on the thickness, density and pore size of the electrospun nanofiber layer, therefore this bonding method may be preferable in applications in which maintaining higher fluid flow rate is desired.

When thermal calendering is used, care must be taken not to over-bond the electrospun nanofiber layer, such that the nanofibers melt and no longer retain their structure as individual fibers. In the extreme, over-bonding will result in the nanofibers melting completely such that a film is formed. One or both of the nip rolls used is heated to a temperature of between about ambient temperature, e.g., about 25° C. and about 300° C. The porous nanofiber medium and/or porous support or substrate, can be compressed between the nip rolls at a pressure ranging from about 0 lb/in to about 1000 lb/in (178 kg/cm).

Calendering conditions, e.g., roll temperature, nip pressure and line speed, can be adjusted to achieve the desired solidity. In general, application of higher temperature, pressure, and/or residence time under elevated temperature and/or pressure results in increased solidity.

Other mechanical steps, such as stretching, cooling, heating, sintering, annealing, reeling, unreeling, and the like, may optionally be included in the overall process of forming, shaping and making the composite filtration medium as desired.

The porosity of the composite filtration medium taught herein can be modified as a result of calendaring, wherein the porosity ranges from about 5% to about 90%.

Additionally, the benefits of the nanofiber liquid filtration media as taught herein were observed to be more pronounced at lower nanofiber mat thicknesses, and therefore shorter spin times. These benefits can also be utilized on a moving web that will directly translate into faster production line speeds. By spinning the nanofiber layer on a smoother substrate surface, the same retention was observed to be achieved but at a lower nanofiber layer thickness. These advantages result in both economic benefits from faster production rate, and in greater permeability of a thinner nanofiber layer. An added benefit of reduced thickness of is the ability to pack more filtration material into the size device, resulting in a greater filtration area at the same footprint, a convenience and economical benefit of end user.

Exemplative Processes for Producing Electrospun Nanofibers

The processes for making the electrospun nanofiber layers are taught, for example in WO 2005/024101, WO 2006/131081, and WO 2008/106903 each incorporated herein by reference in their entirety, and each assigned to Elmarco s.r.o., of Liberec, Czech Republic.

WO 2005/024101, titled “A Method Of Nanofibres Production From Polymer Solution Using a Electrostatic Spinning And A Device For Carrying Out The Method”, teaches, for example, producing nanofibers from a polymer solution inside a vacuum chamber using electrostatic spinning in an electric field created between a rotating charged electrode and a counter electrode having a different potential.

The polymer solution is held in a container having at least one polymer solution inlet and outlet. The inlet and outlet serve to circulate the polymer solution and maintain the polymer solution at a constant height level in the container.

An auxiliary drying air supply, which can be heated if needed, is located between the charged electrode and the counter electrode. One side of the rotating charged electrode is immersed in the polymer solution such that a portion of the solution is taken up by the outer surface of the rotating charged electrode, and spun into the region of the vacuum chamber between rotating the charged electrode and the counter electrode where the electric field is formed. There the polymer solution forms Taylor cones having a high stability on the surface of the rotating charged electrode which presents locations for primary formation of the nanofibers.

The counter electrode has a cylindrical surface made of a perforated conducting material that forms one end of a vacuum chamber connected to a vacuum source. Part of the surface of the counter electrode located near the rotating charged electrode, serves as a conveyor surface for a backing fabric material which supports the electrospun nanofibers when deposited thereon. The backing fabric support material is positioned on an unreeling device arranged on one side of the vacuum chamber and on a reeling device arranged on the other side of the vacuum chamber.

Test Methods

Basis weight was determined according to ASTM procedure D-3776, “Standard Test Methods for Mass Per Unit Area (Weight) of Fabric”, which is incorporated herein by reference in its entirety and reported in g/m².

Porosity was calculated by dividing the basis weight of the sample in g/m² by the polymer density in g/cm³, by the sample thickness in micrometers, multiplying by 100, and subtracting the resulting number from 100, i.e., porosity=100−[basis weight/(density×thickness)×100].

Fiber diameter was determined as follows: A scanning electron microscope (SEM) image was taken at 20,000 or 40,000 times magnification of each side of nanofiber mat sample. The diameter of at least ten (10) clearly distinguishable nanofibers were measured from each SEM image and recorded. Irregularities were not included (i.e., lumps of nanofibers, polymer drops, intersections of nanofibers, etc.). The average fiber diameter for both sides of each sample was calculated and averaged to result in a single average fiber diameter value for each sample.

Thickness was determined according to ASTM procedure D1777-96, “Standard Test Method for Thickness of Textile Materials”, which is incorporated herein by reference in its entirety, and is reported in micrometers (μm).

Mean flow bubble point was measured according to ASTM procedure Designation E 1294-89, “Standard Test Method for Pore Size Characteristics of Membrane Filters Using Automated Liquid Porosimeter”, by using automated bubble point method from ASTM Designation F 316 using a custom-built capillary flow porosimeter, in principle similar to a commercial apparatus from Porous Materials. Inc. (PMI), Ithaca, N.Y. Individual samples of 25 mm in diameter were wetted with isopropyl alcohol. Each sample was placed in a holder, and a differential pressure of air was applied and the fluid removed from the sample. The differential pressure at which wet flow is equal to one-half the dry flow (flow without wetting solvent) is used to calculate the mean flow pore size using software supplied by PMI.

Flux is the rate at which fluid passes through the sample of a given area and was measured by passing deionized water through filter medium samples having a diameter of 47 (9.6 cm² filtration area) mm. The water was forced through the samples using about 25 in Hg vacuum on the filtrate end via a side arm flask.

The effective pore size of the electrospun mat was measured using conventional membrane techniques such as bubble point, liquid-liquid porometry, and challenge test with particles of certain size. It is generally known that the effective pore size of a fibrous mat generally increases with the fiber diameter and decreases with porosity.

Bubble point test provides a convenient way to measure effective pore size. Bubble point is calculated from the following equation:

$$P = \frac{2 γ}{r} cos θ ,$$

where P is the bubble point pressure, γ is the surface tension of the probe fluid, r is the pore radius, and θ is the liquid-solid contact angle.

Brevundimonas diminuta (B. diminuta) retention was measured in accordance with ASTM procedure F838-83, “Standard Test Method for Determining Bacterial Retention of Membrane Filters Utilized for Liquid Filtration”. Porous nanofiber media to be tested were cut in 25 mm discs, including the corresponding substrates they were spun on, and sealed in overmolded polypropylene devices of the same type as the OptiScale 25 disposable capsule filter devices commercially available from EMD Millipore Corporation. The devices include an air vent to prevent air locking, and have an effective filtration area of 3.5 cm².

Samples were produced on a NS 3W1000U, (Elmarco s.r.o. Liberec. CZ), retrofitted with a 50 cm long electrode. On this instrument, samples were produced continuously in a roll to roll basis where the substrate moves over one spinning electrode at a constant speed

Retention assurance analysis: High level of retention of microorganisms is required for critical filtration applications. Following the ASTM procedure F838-83, “Standard Test Method for Determining Bacterial Retention of Membrane Filters Utilized for Liquid Filtration”, bacterial retention of each sample was determined in which values greater than the assay limit are considered fully retention of bacteria. One can predict the performance of a filter as a function of physical properties of that filter by running a regression analysis on the retention data. ([Blanchard, (2007), Quantifying Sterilizing Membrane Retention Assurance, BioProcess International, v.5, No. 5, pp. 44-51]. In cases where uncertain/truncated data points are present, due to the fact that they lie above the assay limit of the test, one common technique that is used to take those data points into consideration is to run censored regression with life data analysis. Regression with life data analysis was run on bacterial retention data gathered from nanofibers produced on different substrates, in order to determine the bacterial retention assurance of the nanofiber filters. Regression with life data function of Minitab16 was used for determining bacterial retention assurance and the resulting regression tables were provided. Tables display a Predictor and a Coefficient column. The first Predictor is the Intercept where the y-axis intercept of the regression line can be found in the corresponding Coefficient column. The second Predictor is the x-axis modeling parameter title (in our examples; mat thickness) as the predicted slope where the value is tabulated under the corresponding Coefficient column. Regression analysis was conducted on data from each substrate separately assuming normal distribution, setting retention [−log(cfu)] as the variable and mat thickness as the modeling parameter. All data was censored by whether it is at the assay limit or not. A total of (censored plus uncensored) at least 15 data points were used for regression analysis. Linear regression lines were plotted using the predicted intercept and slope values determined by the regression analysis.

Surface roughness of the substrates was measured by an optical profilometer, preferably LEXT OLS4000 3D Laser Measuring Microscope by Olympus. LEXT OLS4000 microscope utilizes a 405 nm wavelength laser for acquiring 3D images in confocal mode. Resulting 3D images can then further be used for roughness measurements and analysis. Due to the micro size of the laser spot the laser microscope can measure the surface roughness in the micro scale with much higher resolution than a conventional stylus system can. In addition to its high resolution, another advantage of this technique is that the measurement is done without any contact to the surface. This feature is significant when one deals with, among other properties, compressible substrates, like non-wovens. Preferably 3D images were acquired using MPlanFL N 5× objective lens, resulting in a 10 um z-directional step height, at the Fine setting. Substrate samples were taped to the motorized microscope stage with the surface of interest facing the objective lens, prior to imaging. Color and laser images were acquired by determining-top and bottom of a sample via registering the last fiber in focus at each surface. Stitching function was used to acquire a representative area of >4.5 mm². The area can be any shape, at anywhere on the substrate, with any angle with respect to the machine direction. Upon completion of 3D image acquisition a Flat Noise filter (Gaussian filter) was applied along with a λ_{c} cut off of 250 um. Following ISO 25178, S_{q} (root mean square height; standard deviation of the height distribution, or RMS surface roughness) and S_{z} (Maximum height; height between the highest peak and the deepest valley) and Sₚ (maximum peak height) and Sᵥ (maximum pit depth or maximum valley height) and Sₐ (arithmetic mean height) values were calculated on the filtered data set. Alternatively, al least three different representative >4.5 mm² area regions can be measured and S_{q} can be averaged over these areas.

Hereinafter the composite liquid filtration platform will be described in more detail in the following examples. The examples of the present invention will demonstrate that a composite electrospun nanofiber mat can simultaneously possess both low thickness, therefore high permeability, and high retention of bacteria

### EXAMPLES

### Example 1

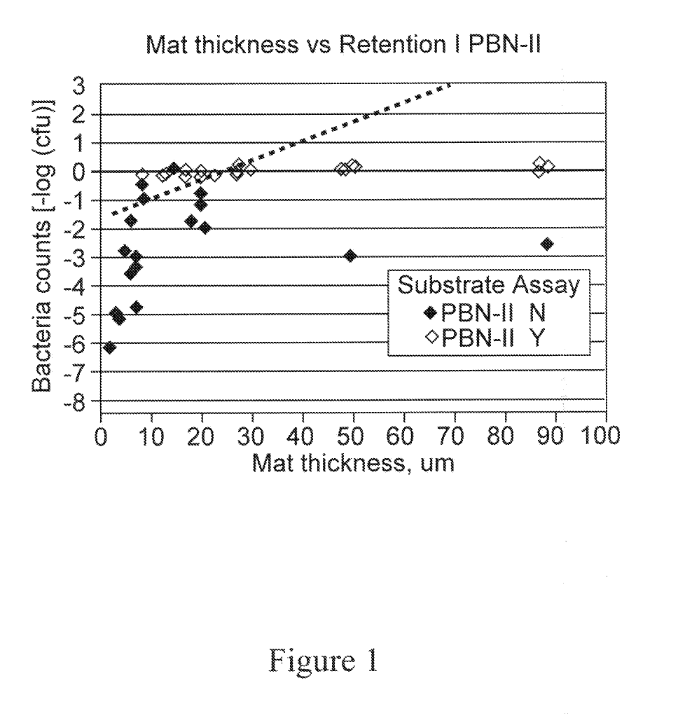

Electrospun nanofiber mats were produced on a traditional coarse non-woven. Coarse non-woven substrate was purchased from Cerex Advanced Fabrics, Inc., Cantonment, Fla., USA, manufacturer's code PBN-II. The spinning solutions were prepared by mixing 13% Nylon 6 (Ultramid® grade B 27 from BASF Corp., Florham Park, N.J., USA) with a blend of acetic acid and formic acid (2:1 weight ratio) for 5 hours at 80° C. The solutions were immediately spun using a 6-wire spinning electrode under nominal 80 kV electric field. A series of samples of variable nanofiber mat thickness were produced on PBI-II non-woven. The surface roughness parameters of the substrate was characterized using a 3D image acquired by LEXT OLS4000 3D laser measuring microscope. 25 mm disc samples were overmolded into devices and bacterial retention tests were conducted. Retention assurance analysis was conducted using censored regression with life data. The mat thickness, bacteria retention data and the regression prediction is plotted in FIG. 1. Jitter was added to x and y data during plotting in order to distinguish replicates.

A regression table is provided in Table 1.

TABLE 1
Regression Table PBN-II

| | | Standard | | | 95.0% Normal CI | |
|---|---|---|---|---|---|---|
| Predictor | Coef | Error | Z | P | Lower | Upper |
| Intercept | −1.65977 | 0.708009 | −2.34 | 0.019 | −3.04744 | −0.272097 |
| Mat thickness, um | 0.0665466 | 0.0246361 | 2.70 | 0.007 | 0.0182608 | 0.114832 |
| Scale | 2.72668 | 0.474499 | | | 1.93868 | 3.83496 |

### Example 2

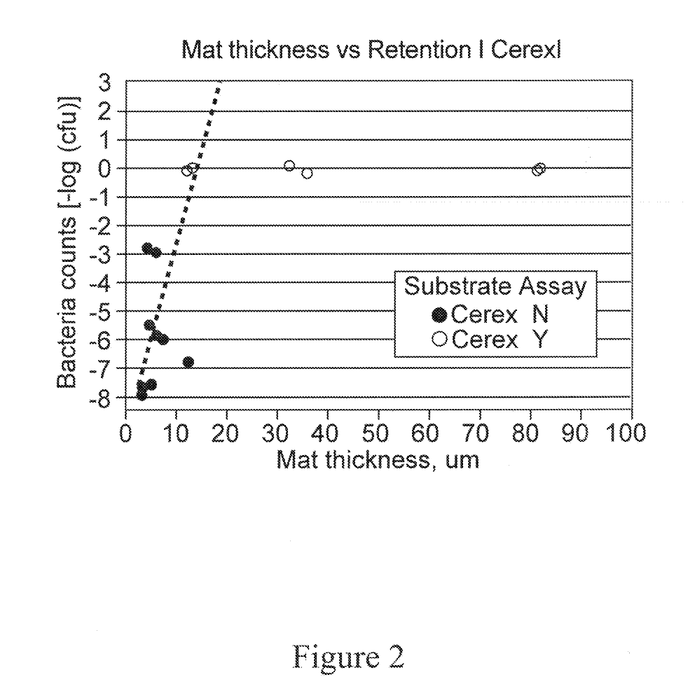

Electrospun nanofiber mats were produced on a specially selected smooth non-woven. Smooth non-woven substrate was purchased from Cerex Advanced Fabrics, Inc., Cantonment, Fla., USA, manufacturer's code Cerex. The spinning solutions were prepared by mixing 13% Nylon 6 (Ultramid® grade B 27 from BASF Corp., Florham Park, N.J., USA) with a blend of acetic acid and formic acid (2:1 weight ratio) for 5 hours at 80° C. The solutions were immediately spun using a 6-wire spinning electrode under nominal 80 kV electric field. A series of samples of variable nanofiber mat thickness were produced on Cerex non-woven. The surface roughness parameters of the substrate was characterized using LEXT OLS4000 3D laser measuring microscope. 25 mm disc samples were overmolded into devices and bacterial retention tests were conducted. Retention assurance analysis was conducted using censored regression with life data. The mat thickness, bacteria retention data and the regression prediction is plotted in FIG. 2. Jitter was added to x and y data during plotting in order to distinguish replicates.

A regression table is provided in Table 2.

TABLE 2
Regression Table Cerex

| | | Standard | | | 95.0% Normal CI | |
|---|---|---|---|---|---|---|
| Predictor | Coef | Error | Z | P | Lower | Upper |
| Intercept | −9.65703 | 1.81490 | −5.32 | 0.000 | −13.2142 | −6.09989 |
| Mat thickness, um | 0.668104 | 0.225897 | 2.96 | 0.003 | 0.225353 | 1.11085 |
| Scale | 2.42148 | 0.594959 | | | 1.49603 | 3.91942 |

### Example 3

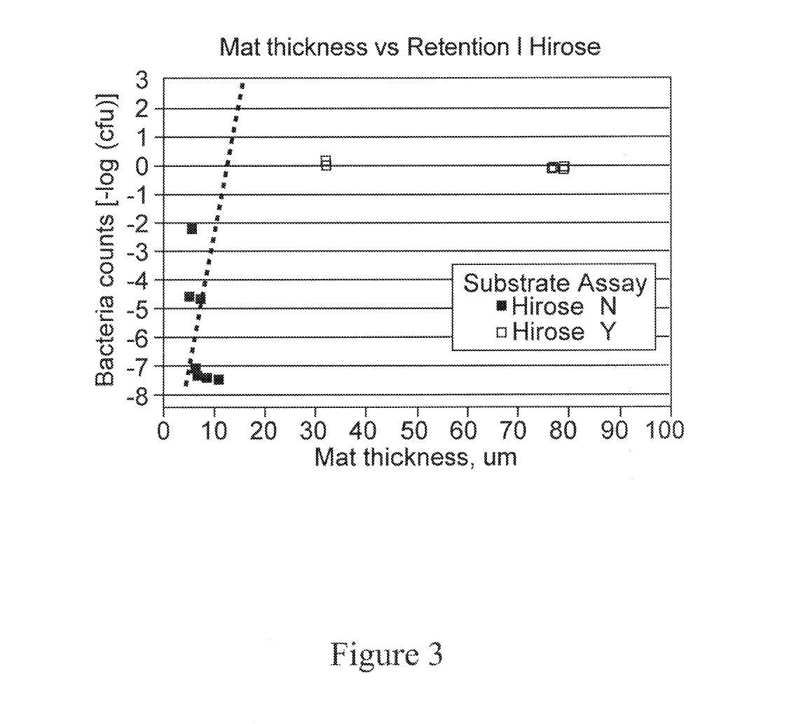

Electrospun nanofiber mats were produced on a specially selected smooth non-woven. Smooth non-woven substrate was purchased from Hirose Paper Manufacturing Co., Ltd, Tosa-City, Kochi. Japan, part number #HOP-60HCF. The spinning solutions were prepared by mixing 13% Nylon 6 (Ultramid® grade B 27 from BASF Corp., Florham Park, N.J., USA) with a blend of acetic acid and formic acid (2:1 weight ratio) for 5 hours at 80° C. The solutions were immediately spun using a 6-wire spinning electrode under nominal 80 kV electric field. A series of samples of variable nanofiber mat thickness were produced on Hirose non-woven. The surface roughness parameters of the substrate was characterized using LEXT OLS4000 3D laser measuring microscope. 25 mm disc samples were overmolded into devices and bacterial retention tests were conducted. Retention assurance analysis was conducted using censored regression with life data. The mat thickness, bacteria retention data and the regression prediction is plotted in FIG. 3. Jitter was added to x and y data during plotting in order to distinguish replicates.

A regression table is provided in Table 3.

TABLE 3
Regression Table Hirose

| | | Standard | | | 95.0% Normal CI | |
|---|---|---|---|---|---|---|
| Predictor | Coef | Error | Z | P | Lower | Upper |
| Intercept | −11.6259 | 3.38429 | −3.44 | 0.001 | −18.2590 | −4.99277 |
| Mat thickness, um | 0.967087 | 0.442396 | 2.19 | 0.029 | 0.100007 | 1.83417 |
| Scale | 2.78981 | 0.732732 | | | 1.66729 | 4.66809 |

Regression with life data analysis was also conducted on the entire dataset assuming normal distribution, setting retention as the variable and mat thickness as the modeling parameter and censoring for whether the point is at the assay limit or not.

A regression table is provided in Table 4.

TABLE 4

| | | Standard | | | 95.0% Normal CI | |
|---|---|---|---|---|---|---|
| Predictor | Coef | Error | Z | P | Lower | Upper |
| Intercept | −9.76582 | 1.98708 | −4.91 | 0.000 | −13.6604 | −5.54420 |
| Mat thickness, um | 0.687914 | 0.245782 | 2.80 | 0.005 | 0.206190 | 1.16964 |

Substrate

| | | | | | | |
|---|---|---|---|---|---|---|
| Hirose | −1.72072 | 3.70666 | −0.46 | 0.642 | −8.98564 | 5.54420 |
| PBN-II | 8.09440 | 2.10773 | 3.84 | 0.000 | 3.96332 | 12.2255 |

Substrate*Mat thickness, um

| | | | | | | |
|---|---|---|---|---|---|---|
| Hirose | 0.257587 | 0.471848 | 0.55 | 0.585 | −0.667217 | 1.18239 |
| PBN-II | −0.622216 | 0.246407 | −2.53 | 0.012 | −1.10516 | −0.139267 |
| Scale | 2.66565 | 0.333225 | | | 2.08640 | 3.40572 |

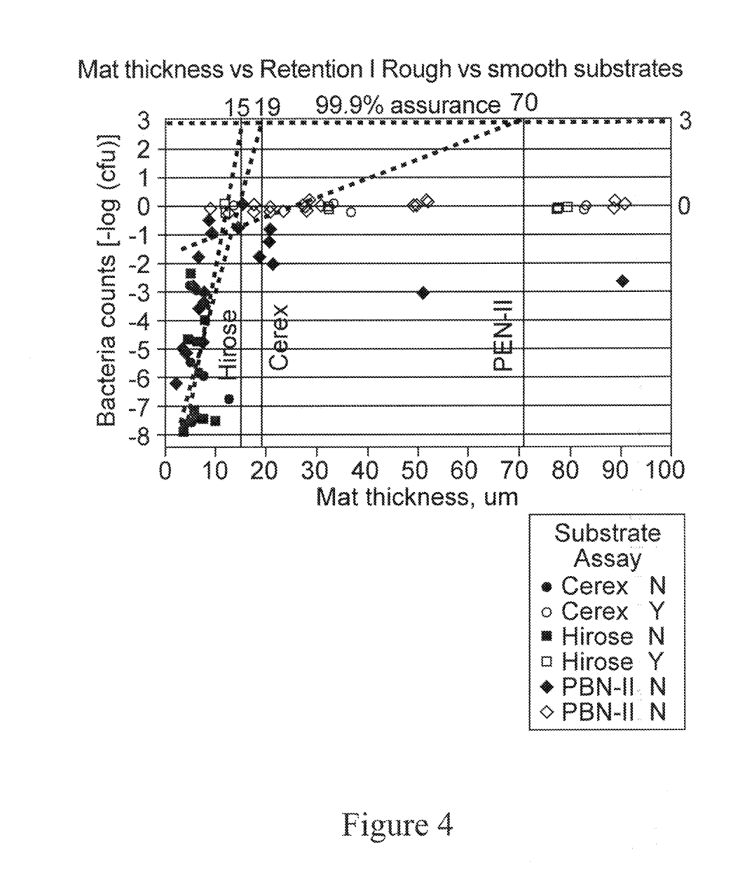

In this analysis the type of substrate was used as a factor in the analysis in order to determine whether the data sets used are representing different populations. Compared to the Cerex reference substrate. Hirose dataset resulted in high p values for both the intercept and the slope predictions for a regression line indicating the two data sets are behaving similarly. However compared to the Cerex reference substrate, PBN-II dataset resulted in low p values for both the intercept and the slope predictions for a regression line indicating the two data sets are behaving differently. These results indicate that PBN-II data set is behaving statistically differently compared to Cerex and Hirose data sets. All data with the calculated regression lines were plotted in FIG. 4, grouped with respect to substrates and whether the data points were at assay limit or not. Jitter was added to x and y data during plotting in order to distinguish replicates. Thicknesses predicted for 99.9% assurance (+3 logs on y-axis) by the regression lines were marked by reference lines at 70 um for PBN-II, 19 um for Cerex and 15 um for Hirose.

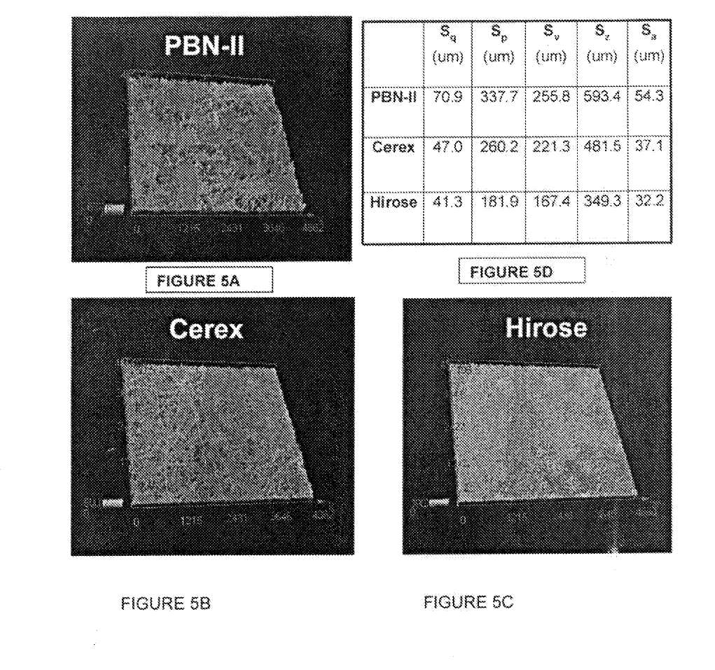

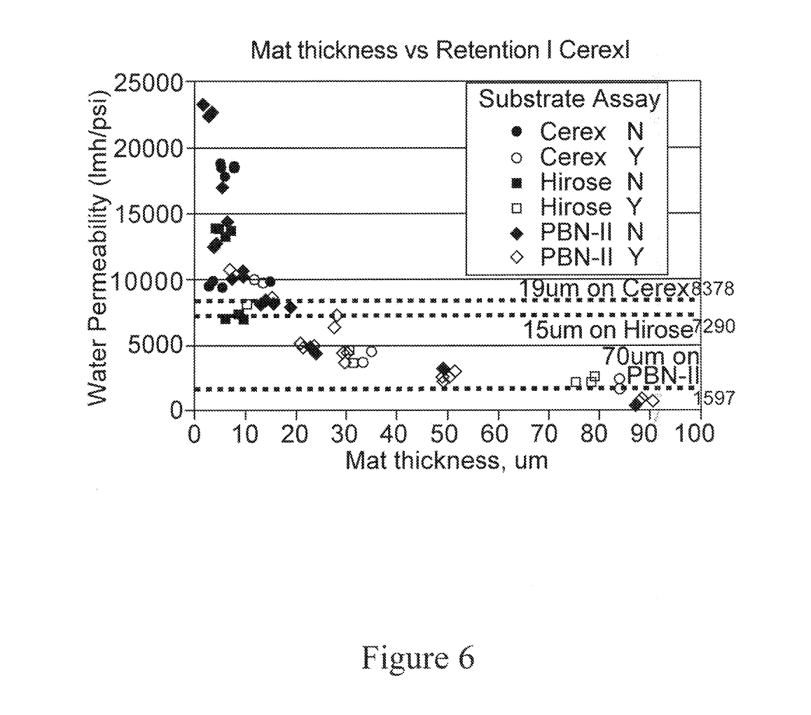

3D images depicted in FIGS. 5A, 5B and 5C were used for calculating surface roughness parameters along with the calculated values shown in FIG. 5D. Mat thickness vs Permeability is plotted in FIG. 6 where data is grouped with respect to substrates used and also whether the data point was at assay limit or not, i.e.: Assay=Y (Yes) or N (No). Fully retentive data points over 10,000 lmh/psi are displayed. Reference lines at y-values correspond to the interpolated permeabilities expected from nanofiber mat thicknesses predicted by the regression lines for 99.9% retention assurance (+3 logs on y-axis). Permeabilities were interpolated assuming linear relationship in between the data points above and below the predicted thickness.

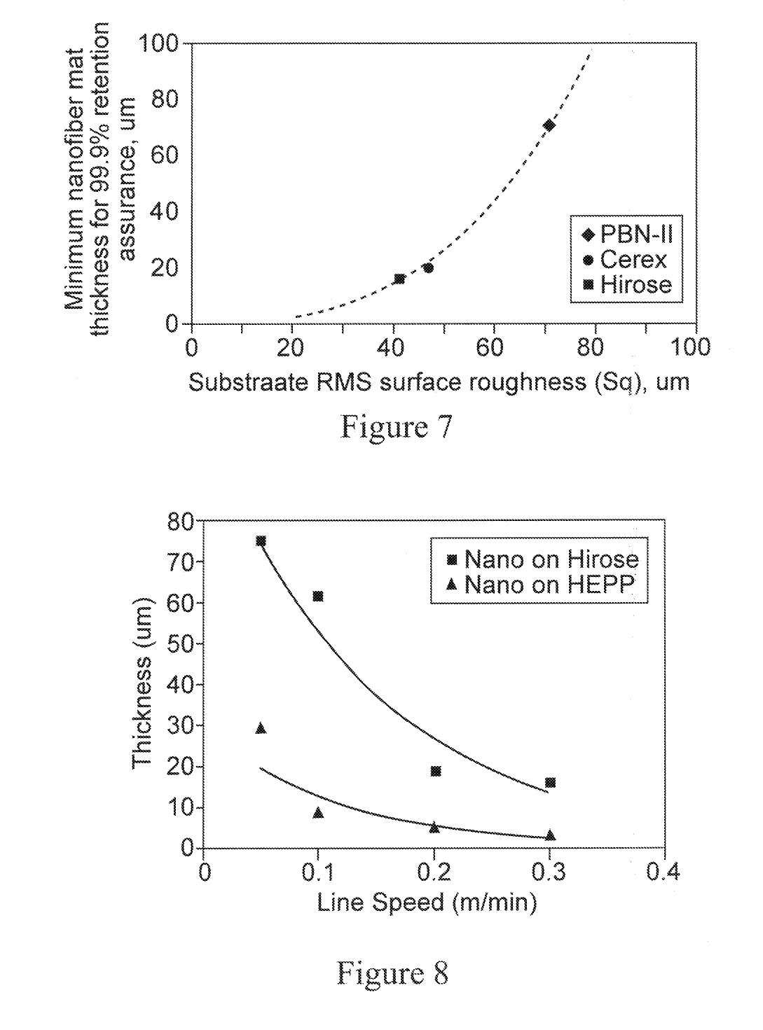

FIG. 7 displays the relationship between substrate surface roughness and minimum thickness necessary for full retention with 99.9% assurance (the line is to guide the eye). Low RMS surface roughness of the substrate e.g., less than 70 um, is necessary to achieve thinner nanofiber mats e.g., less than 100 um, that have high retention assurance with permeabilities at least as high as commercially available sterilizing grade membranes like Millipore Express® SHF filter from, EMD Millipore Corporation, Billerica, Mass., e.g., more than 1200 lmh/psi.

### Example 4

The spinning solution was prepared by mixing 12% Nylon 6 (Ultramid® grade B 24 N 02 from BASF Corp., Florham Park, N.J., USA) with a blend of acetic acid and formic acid (2:1 weight ratio) for 5 hours at 80° C. The solution was immediately spun using a 6-wire spinning electrode under 82 kV electric field on a either a smooth nonwoven (supplied by Hirose) or a 0.5 micron-rated microfiltration membrane available as prefilter layer of Millipore Express® SHC filter, EMD Millipore Corporation, Billerica, Mass. The line speed (spinning time) was varied to observe differences in nanofiber collection rates (See FIG. 8).

Methods of Use

The polymeric nanofiber filtration media in accordance with the present invention are useful in the food, beverage, pharmaceuticals, biotechnology, microelectronics, chemical processing, water treatment, and other liquid treatment industries.

The polymeric nanofiber filtration media as taught herein are highly effective for filtering, separating, identifying, and/or detecting microorganisms from a liquid sample or liquid stream, as well as removing viruses or particulates.

The polymeric nanofiber filtration media as taught herein are particularly useful in critical filtration of solutions and gases that may come into contact with or may contain pharmaceutical and biopharmaceutical compounds intended for human or animal administration.

The polymeric nanofiber filtration media as taught herein may be used with any liquid sample preparation methods including, but not limited to, chromatography; high pressure liquid chromatography (HPLC); electrophoresis; gel filtration; sample centrifugation; on-line sample preparation; diagnostic kits testing; diagnostic testing; high throughput screening; affinity binding assays; purification of a liquid sample; size-based separation of the components of the fluid sample; physical properties based separation of the components of the fluid sample; chemical properties based separation of the components of the fluid sample; biological properties based separation of the components of the fluid sample; electrostatic properties based separation of the components of the fluid sample; and, combinations thereof.

The polymeric nanofiber filtration media as taught herein can be a component or part of a larger filtration device or system.

Kits

The polymeric nanofiber filtration media as taught herein can be provided as a kit, which may be used to remove microorganisms and particulates from a liquid sample or stream. The kit may comprise, for example, one or more composite filtration medium including an electrospun nanofiber liquid filtration layer on a smooth non-woven support as taught herein, as along with one or more liquid filtration devices or supports for incorporating and using the composite filtration medium.

The kit may contain one or more control solutions, and may optionally include various buffers useful in the methods of practicing the invention, such as wash buffers for eliminating reagents or eliminating non-specifically retained or bound material may optionally be included in the kit.

Other optional kit reagents include an elution buffer. Each of the buffers may be provided in a separate container as a solution. Alternatively the buffers may be provided in dry form or as a powder and may be made up as a solution according to the user's desired application. In this case the buffers may be provided in packets.

The kit may provide a power source in instances where the device is automated as well as a means of providing an external force such as a vacuum pump. The kit may also include instructions for using the electrospun nanofiber containing liquid filtration medium, device, support or substrate, and/or for making up reagents suitable for use with the invention, and methods of practicing invention. Optional software for recording and analyzing data obtained while practicing the methods of the invention or while using the device of the invention may also be included.

The term “kit” includes, for example, each of the components combined in a single package, the components individually packaged and sold together, or the components presented together in a catalog (e.g., on the same page or double-page spread in the catalog).

The above description fully discloses the invention including preferred embodiments thereof. Without further elaboration, it is believed that one skilled in the area can, using the preceding description, utilize the present invention to its fullest extent. Therefore the Examples herein are to be construed as merely illustrative and not a limitation of the scope of the present invention in any way.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. The embodiments of the invention in which an exclusive property or privilege is claimed are defined as follows.

What is claimed is:

1. A method of removing microorganisms from a liquid sample comprising the steps of: a) providing a liquid sample containing microorganisms;
b) providing a porous nanofiber containing media including a porous polymeric nanofiber layer produced on a support having a surface,
wherein at least on the surface of the support facing the porous polymeric nanofiber layer the root mean square height of the surface is less than about 70 μm,
c) passing the liquid sample containing microorganisms through the porous media using the standard test method for determining microorganism retention, and
d) collecting a filtrate free of microorganisms.

2. The method according to claim 1, wherein at least on the surface of the support facing the porous polymeric nanofiber layer the root mean square height of the surface is less than about 47 μm.

3. The method according to claim 1, wherein the thickness of the porous polymeric nanofiber layer is less than about 100 μm.

4. The method according to claim 1, wherein the thickness of the porous polymeric nanofiber layer is less than about 70 μm.

5. The method according to claim 1, wherein the thickness of the porous polymeric nanofiber layer is less than about 55 μm.

6. The method according to claim 1, wherein the support is selected from the group consisting of nonwovens, wovens, and films.

7. The method according to claim 1, wherein the support is a porous nonwoven.

8. The method according to claim 1, wherein the porous polymeric nanofiber layer is an electrospun mat.

9. The method according to claim 1, wherein the porous polymeric nanofiber layer comprises a polymer selected from the group consisting of polyimide, aliphatic polyamide, aromatic polyamide, polysulfone, cellulose acetate, polyether sulfone, polyurethane, poly(urea urethane), polybenzimidazole, polyetherimide, polyacrylonitrile, poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene), a copolymer, derivative compounds, or blends thereof.

10. The method according to claim 1, wherein the porous polymeric nanofiber layer comprises an aliphatic polyamide.

11. The method according to claim 1, wherein the porous nanofiber containing media has a thickness from about 1 μm to about 500 μm.

12. The method according to claim 1, wherein the porous nanofiber containing media has a thickness from about 5 μm to about 100 μm.

13. The method according to claim 1, wherein the porous polymeric nanofiber layer is formed by a process selected from the group consisting of electrospinning and electroblowing.

14. The method according to claim 1, wherein the support has a thickness from about 10 μm to about 1000 μm.

15. The method according to claim 1, wherein the support comprises one or more layers produced by melt-blowing, wet-laying, spun-bonding, calendering and combinations thereof.

16. The method according to claim 1, wherein the support comprises thermoplastic polymers, polyolefins, polypropylene, polyesters, polyamides, copolymers, polymer blends, and combination thereof.

17. The method according to claim 1, wherein the porous nanofiber containing media further comprises a porous material adjacent the nanofiber layer, and the tightest pore size of the nanofiber layer is smaller than the tightest pore size of the porous material.

18. The method according to claim 17, wherein porous support material comprises one or more layers selected from the group consisting of spunbonded nonwovens, meltblown nonwovens, needle punched nonwovens, spunlaced nonwovens, wet laid nonwovens, resin-bonded nonwovens, woven fabrics, knit fabrics, paper, and combinations thereof.

19. The method according to claim 1, wherein the porous nanofiber containing media has a microorganism Log Reduction Value (LRV) greater than about 8 with 99.9% assurance and a liquid permeability greater than about 1200 LMH/psi.

20. The method according to claim 19, wherein the liquid permeability is greater than about 5,000 LMH/psi.

21. A method of removing microorganisms from a liquid sample comprising the steps of: a) providing a liquid sample containing microorganisms;
b) providing a porous nanofiber containing media including a porous polymeric electrospun nanofiber mat produced on a support having a surface,
wherein at least on the surface of the support facing the porous polymeric electrospun nanofiber mat the root mean square height of the surface is less than about 70 μm, said media having a microorganism Log Reduction Value (LRV) greater than about 8 with 99.9% assurance and a liquid permeability greater than about 1200 LMH/psi,
c) passing the liquid sample containing microorganisms through the porous nanofiber containing media, and
d) collecting the filtrate.

22. The method according to claim 21, wherein at least on the surface of the support facing the porous polymeric electrospun nanofiber mat the root mean square height of the surface is less than about 47 μm.

23. The method according to claim 21, wherein the liquid permeability is greater than about 5,000 LMH/psi.

24. The method according to claim 21, wherein the thickness of the porous polymeric electrospun nanofiber mat is less than about 100 μm.

25. The method according to claim 21, wherein the porous polymeric electrospun nanofiber mat comprises an aliphatic polyamide.

26. The method according to claim 21, wherein the porous media has a thickness from about 1 μm to about 500 μm.

27. The method according to claim 21, wherein the support is selected from the group consisting of nonwovens, wovens, and films.

28. The method according to claim 21, wherein the support is a porous nonwoven.

29. The method according to claim 21, wherein the support comprises thermoplastic polymers, polyolefins, polypropylene, polyesters, polyamides, copolymers, polymer blends, and combination thereof.

30. The method according to claim 21, wherein the support has a thickness from about 10 μm to about 1000 μm.

31. The method according to claim 21, wherein the porous media further comprises a porous material adjacent the porous polymeric electrospun nanofiber mat, and the tightest pore size of the nanofiber mat is smaller than the tightest pore size of the porous material.

32. The method according to claim 31, wherein porous material comprises one or more layers selected from the group consisting of spunbonded nonwovens, meltblown nonwovens, needle punched nonwovens, spunlaced nonwovens, wet laid nonwovens, resin-bonded nonwovens, woven fabrics, knit fabrics, paper, and combinations thereof.

33. A method of making a porous nanofiber containing media for removing microorganisms from a liquid sample comprising the steps of:
a. forming a porous nanofiber polymeric layer on a substrate by a process selected from the group consisting of electrospinning and electroblowing, wherein at least on the surface of the substrate facing the porous nanofiber polymeric layer the root mean square height of the surface is less than about 70 μm,
b. depositing the porous nanofiber polymeric layer onto a porous support, and
c. removing the substrate.

34. The method according to claim 33, wherein the microorganism is a mycoplasma or a virus.

35. The method according to claim 33, wherein at least on the surface of the substrate facing the porous nanofiber polymeric layer the root mean square height of the surface is less than about 47 μm.

36. The method according to claim 33, wherein the porous nanofiber containing media has a microorganism Log Reduction Value (LRV) greater than about 8 with 99.9% assurance and a liquid permeability greater than about 1200 LMH/psi/.

37. The method according to claim 36, wherein the liquid permeability is greater than about 5,000 LMH/psi.

38. The method according to claim 33, wherein the porous nanofiber polymeric layer is an electrospun mat.

39. The method according to claim 38, wherein the thickness of the mat is less than about 100 μm.

40. The method according to claim 39, wherein the mat comprises an aliphatic polyamide.

41. The method according to claim 33, wherein the tightest pore size of the porous nanofiber polymeric layer is smaller than the tightest pore size of the porous support.

42. The method according to claim 33, wherein porous support comprises one or more layers selected from the group consisting of spunbonded nonwovens, meltblown nonwovens, needle punched nonwovens, spunlaced nonwovens, wet laid nonwovens, resin-bonded nonwovens, woven fabrics, knit fabrics, paper, and combinations thereof.

43. The method according to claim 33, wherein the porous nanofiber containing media has a thickness from about 1 μm to about 500 μm.

44. The method according to claim 33, wherein the substrate is selected from the group consisting of nonwovens, wovens, and films.
